(19) United States
(12) Patent Application Publication
(10) Pub. No.: US 2021/0295738 A1
(43) Pub. Date: Sep. 23, 2021

(54) PROVIDING MATH CONTENT FOR VISUALLY IMPAIRED

(71) Applicant: Continual Engine IP, LLP, Dallas, TX (US)

(72) Inventors: Gautam Kapoor, Bangalore (IN); Vikram Prasanna, Bangalore (IN); Mousumi Kapoor, Bangalore (IN); Pranshu Agarwal, Bangalore (IN); Ravi Vemagiri, Bangalore (IN); Ranjeet Kumar, Bangalore (IN)

(21) Appl. No.: 17/133,694

(22) Filed: Dec. 24, 2020

(30) Foreign Application Priority Data
Dec. 24, 2019 (IN) 201941053667

(51) Int. Cl. G09B 21/00; G06K 9/46; G06F 40/284; G06K 9/52; G09B 19/02; G06N 20/00

(52) U.S. Cl. CPC G09B 21/006; G06K 9/469; G06F 40/284; G09B 21/003; G09B 19/025; G06N 20/00; G06K 9/52

(57) ABSTRACT

An aspect of the present disclosure is directed to providing assistive services to users. Upon receiving an image of math content from a user, a server system processes the image to determine a set of characteristics of the image and then generates a text representing a description of the math content of the image based on the determined set of characteristics. The server system may employ machine learning (ML) techniques such as sequence-to-sequence modelling, and AI (artificial intelligence) techniques in addition to digital image processing methods for converting the images to text. The server system then provides the text to the user in an output format (e.g., Braille, audio) suitable for the user.

### PRIORITY CLAIM

The instant patent application is related to and claims priority from the co-pending India provisional patent application entitled, “PROVIDING MATH CONTENT FOR VISUALLY IMPAIRED”, Serial No.: 201941053667, Filed: 24 Dec. 2019, naming as inventors Gautam Kapoor et al, attorney docket number: CENG-301-INPR, which is incorporated in its entirety herewith.

### BACKGROUND

### Technical Field

The present disclosure relates to providing educational content to visually impaired people and more specifically to providing math content.

### Related Art

The number of people with visual and reading disabilities in the world is large. While Braille books do exist, the cost of producing them is huge. Therefore, many people around the world cannot afford them. Text-to-speech converters are a more cost-effective solution, but unfortunately, they cannot directly describe STEM (Science, Technology, Engineering and Mathematics) equations or graphs with any accuracy. So, most publishers or universities end up leveraging subject matter experts to write descriptions for each of these equations and graphs, which is highly time consuming, expensive and cumbersome.

Accordingly, there is a general need to provide assistive services (e.g., audio) for complex math content in a convenient and cost-effective manner for people with visual and reading disabilities.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a block diagram illustrating the details of implementation of a server system providing assistive services according to several aspects of the present disclosure.

FIG. 3A depicts sample mathematical equations and the corresponding Latex representations and text descriptions in one embodiment.

FIG. 3B depicts sample graphs and the corresponding text descriptions in one embodiment.

FIG. 4 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### SUMMARY

An aspect of the present disclosure is directed to providing assistive services to users. Upon receiving an image of math content from a user, a server system processes the image to determine a set of characteristics of the image and then generates a text representing a description of the math content of the image based on the determined set of characteristics. The server system then provides the text to the user in an output format suitable for the user.

According to another aspect of the present disclosure, if the server system (noted above) determines the image represents a mathematical equation, the server system identifies a sequence of tokens as representing the math content of said image and then converts the sequence of tokens to the text.

According to one more aspect of the present disclosure, for identifying the sequence of tokens, the server system (noted above) generates a machine learning (ML) equation model that correlates portions of images to tokens and then predicts the sequence of tokens for the (received) image based on the ML equation model. In one embodiment, the ML equation model is generated according to sequence-to-sequence ML approach.

According to yet another aspect of the present disclosure, server system (noted above) performs the converting of the sequence of tokens to the text by replacing each token in the sequence of tokens with a corresponding term to form a sequence of terms, wherein the sequence of terms represents the text.

In one embodiment, the sequence of tokens identified is according to Latex representation, and the output format is an audio corresponding to the text. Thus, server system (noted above) operates to convert the equation in the received image to a Latex representation. Latex is a typesetting system that enables users to create documents with formatting using a list of predefined tokens. The Latex representation is then converted to text description. The text description (in Braille format) may be presented to the user or may be converted to audio format.

According to an aspect of the present disclosure, when the server system determines that the received image represents a graph, the server system (noted above) generates a machine learning (ML) graph model that correlates portions of images to characteristics and then predicts the set of characteristics for the (received) image based on the ML graph model. In one embodiment, the ML graph model is generated according to sequence-to-sequence ML approach and the set of characteristics determined for the graph includes a type of the graph, a slope of a line in the graph, and a vertex, roots and direction of a parabola in the graph.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### DETAILED DESCRIPTION

### 1. Example Environment

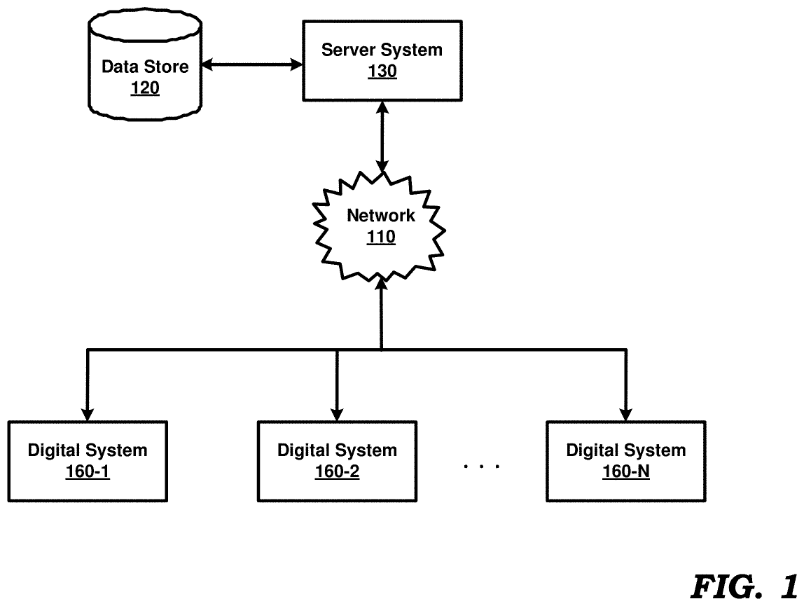

FIG. 1 is a block diagram illustrating an example environment (computing system) in which several aspects of the present disclosure can be implemented. The block diagram is shown containing network 110, data store 120, server system 130 and digital systems 160-1 to 160-N (N representing any arbitrary positive number). Digital systems 160-1 to 160-N are collectively or individually referred by referral numeral 160, as will be clear from the context.

Merely for illustration, only representative number/type of systems are shown in FIG. 1. Many environments often contain many more systems, both in number and type, depending on the purpose for which the environment is designed. Each block of FIG. 1 is described below in further detail.

Network 110 provides connectivity between digital systems 160-1 to 160-N and server system 130, and may be implemented using protocols such as Transmission Control Protocol (TCP) and/or Internet Protocol (IP), well-known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered.

An IP packet is said to be directed to a target system when the destination IP address of the packet is set to the IP address of the target system, such that the packet is eventually delivered to the target system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of a collection of data by server system 130. Data store 120 may contain a repository of images received by server system 130 for conversion to text description. Server system 130 may use the stored images to train ML (machine learning) models according to an aspect of the present disclosure. Data store 120 may be implemented as a database server using relational database technologies and accordingly provide storage and retrieval of data using structured queries such as SQL (Structured Query Language). Alternatively, or in addition, data store 120 may be implemented as a file server providing storage and retrieval of data in the form of files organized as one or more directories, as is well-known in the relevant arts.

Each of digital systems 160-1 to 160-N is shown representing a corresponding end user system such as a personal computer, workstation, mobile station, mobile phones, computing tablets, etc. Each digital system may be used by visually impaired persons to read documents (e.g., PDF files), which contain images that already do not have associated text description. Accordingly, digital system 160 may send such images to server system 130 and receive a suitable text that describes the image. The text thus received may be suitably reproduced using a suitable audio player.

Server system 130, provided according to several aspects of the present disclosure, provides assistive services to users using digital systems 160 as described below with examples.

### 2. Example Implementation

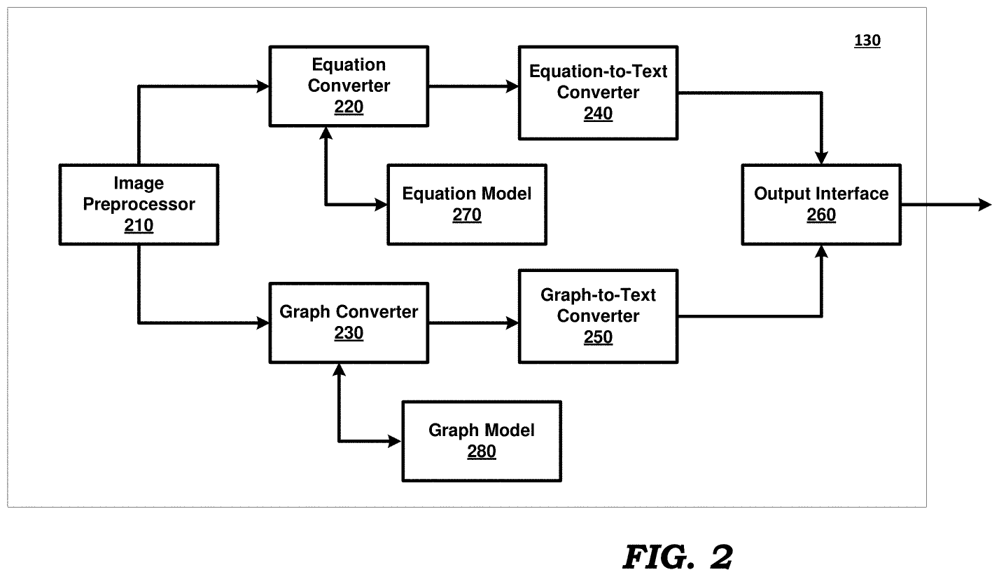

FIG. 2 is a block diagram illustrating the details of implementation of a server system (130) providing assistive services according to several aspects of the present disclosure. Server system 130 is shown containing image preprocessor 210, equation converter 220, graph converter 230, equation-to-text converter 240, graph-to-text converter 250, output interface 260, equation model 270 and graph model 280. Each of the blocks is described in detail below.

Image preprocessor 210 receives images from digital systems 160 over network 110. Several image formats such as JPEG, BMP, PNG, etc. may be supported for conversion. Images in PDF and Word documents may also be sent for conversion by digital system 160. Image preprocessor 210 classifies the received image as a mathematical equation or a graph. If the image represents a mathematical equation, image preprocessor 210 forwards the image to equation converter 220 for further processing. If the image represents a graph, image preprocessor 210 forwards the image to graph converter 230 for further processing

Equation converter 220 converts the image of the mathematical equation to a sequence of tokens according to Latex representation. Equation converter 220 may employ techniques like optical character recognition to identify the parts/characteristics of the mathematical equation. Equation converter 220 identifies a sequence of tokens using the characteristics (parts, type, etc.) and equation model 270.

Equation model 270 represents a machine learning (ML) based model generated for correlating portions of images to tokens. Equation model 270 may use ML techniques like sequence-to-sequence ML approach available from Google[R]. When the model is trained with a large number (e.g., hundreds of thousands) of images and their Latex description/tokens, the model learns the translation between image and its corresponding Latex description/tokens. When a new image is introduced to the model, it uses its learning to predict the Latex description (sequence of tokens) for the new image.

Equation-to-text converter 240 converts the Latex representation of the mathematical equation (received from equation converter 220) to text/description. It may be appreciated that to describe a math equation in text format, it is necessary that the description be unambiguous. So, equation-to-text converter 240 uses specialized terms like start fraction, end fraction, etc. to describe the math equations as depicted in the examples below. Equation-to-text converter 240 passes through the Latex description (sequence of tokens) and converts each latex symbol (token) encountered to a corresponding language (e.g., English) counterpart term/phrase to form a sequence of terms representing the text/description. Equation-to-text converter 240 then forwards the text/description to output interface 260.

Graph converter 230 converts the image of a graph to its defining set of characteristics, depending on the type of graph. For example, if a graph depicts a line, graph converter 230 evaluates its slope. If the graph depicts a parabola, graph converter 230 evaluates the vertex, roots, direction etc. The conversion may be performed using computer vision techniques well known in the relevant arts. In one embodiment, graph converter 230 uses graph model 280 to determine the set of characteristics.

Graph model 280 represents a machine learning (ML) based model generated for correlating portions of images to various characteristics. Graph model 280 may use ML techniques like sequence-to-sequence ML approach available from Google[R]. Graph model 280 may be trained similar to equation model 270 such that when a new image is introduced to the model, it uses its learning to predict the set of characteristics for the new image/graph.

Graph-to-text converter 250 converts the “defining characteristics” (such as slope, vertex, roots, etc. noted above) of the graph to text description. Graph-to-text converter 250 then forwards the text/description to output interface 260.

Output interface 260 forwards the generated text to the digital system requesting text description for the image. Alternatively, output interface may further convert the text description to audio in a known way in case the document containing the image is being played directly to a visually impaired person.

Thus, server system 130 aids digital systems 160 to convert the images to corresponding text for generation of text description. As noted above, server system 130 may employ ML techniques such as sequence-to-sequence modelling, and AI (artificial intelligence) techniques in addition to digital image processing methods for converting the images to text descriptions. In addition, if server system 130 is streaming audio from the contents of a page being read out to a user on digital system 160, server system 130 may convert the text description of the image to audio and stream the same to the user.

The description is continued with respect to illustrating some of the above noted features with respect to sample data.

### 3. Equation Image to Text Conversion

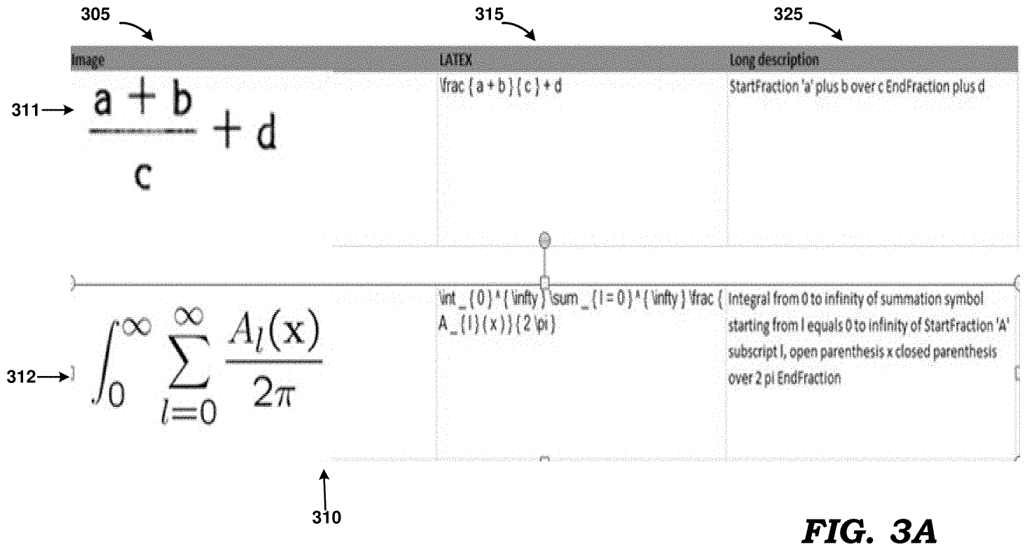

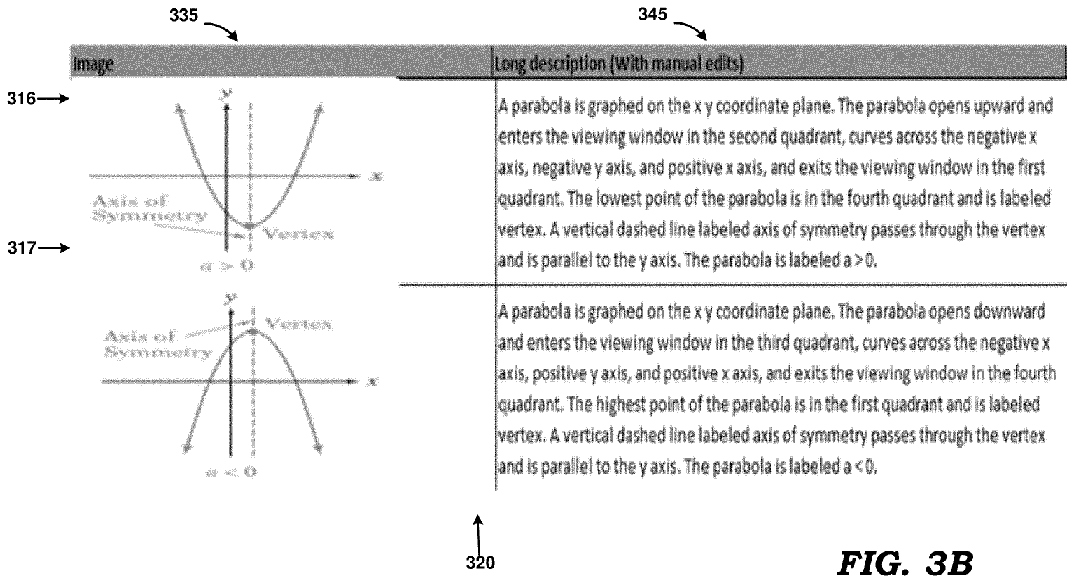

FIG. 3A depicts sample images of mathematical equations and the corresponding Latex representations and text descriptions in one embodiment. FIG. 3A is shown containing table 310. Table 310 is shown containing 2 rows 311 and 312, depicting images of two mathematical equations (in column 305) and their respective Latex representations (in column 315) and text descriptions (in column 325). Additional sample equations/graphs and the corresponding Latex representations and text descriptions are depicted in Appendix A, Appendix B and Appendix C of this document.

It is assumed that image preprocessor 210 on server system 130 receives the image in row 311 of a mathematical equation from digital system 160-1. Image preprocessor 210 may perform certain pre-processing steps on the received image such as binarization and segmentation. Binarization (Converting image to a series of 0 & 1, depending on threshold) removes the color & color gradient information of the image and makes it easier for the model to predict. Segmentation divides the image to separate components like equations, images and text. Image preprocessor 210 then identifies that the received image is a mathematical equation and hence forwards the image to equation converter 220.

Equation converter 220 converts image 311 to Latex representation as shown in column 315 using equation model 270. Equation converter 220 sends the Latex representation to equation-to-text converter 240. Equation-to-text converter 240 converts the Latex representation to text description (as shown in column 325 for row 311). The conversion is done such that the description unambiguously represents the equation in the image.

For example, the equation (a+b)/c cannot be described as a plus b over c as a+(b/c) is also described as a plus b over c. Therefore, specialized terms such as startfraction and endfraction are used to describe the expression as startfraction a+b over c endfraction. a+b/c would be described as a+startfraction b over c endfraction. Thus, equation-to-text converter 220 uses steps to parse through the Latex expression and replace the Latex tokens with certain pre-defined terms.

As another example, the Latex for (a+b)/c is \frac {a+b} {c}. When the parser encounters \frac, it's replaced with “StartFraction”, “{”, denotes beginning of the numerator term. When the parser encounters “}”, it knows that the numerator term has been described so then it replaces “}” with “over”. The next “{” is beginning of denominator and the next “}” is end of denominator. As soon as the parser encounters “}”, the parser replaces the token with “endFraction”. So \frac {a+b} {c} becomes “startFraction a+b over c endFraction” and a+\frac {b} {c} becomes “a+startFraction b over c endFraction”.

Equation-to-text converter 240 sends the text description to output interface 260, which forwards the converted text to the digital system requesting text description for the image. In this manner, server system 130 converts an equation image to text description.

The description is continued to illustrate graph image to text description conversion according to aspects of the present disclosure.

### 4. Graph Image to Text Conversion

FIG. 3B depicts sample graph images and the corresponding text descriptions. FIG. 3B is shown containing table 320 with two columns 335 and 345. Column 335 depicts the graph images. Column 345 depicts the text description of the graph. Table 320 is shown containing rows 316 and 316, representing two sample graph images. Additional sample equations/graphs and the corresponding text descriptions are depicted in Appendix A, Appendix B and Appendix C of this document.

It is assumed that image preprocessor 210 on server system 130 receives the image 316 of a graph from digital system 160-1. As described earlier, image preprocessor 210 identifies that the received image is a graph and hence forwards the image to graph converter 230.

Graph converter 230 uses a combination of computer vision techniques line detection, curve detection, curve fitting etc., mathematical modeling and tracing techniques to identify the type of graph. Graph converter 230 also identifies characteristics of the graph such as quadrants where the graph traverses, the roots of the graph, the maxima and minima of the graph, etc. Graph converter 230 identifies the characteristics using graph model 280 and then forwards the characteristics to graph-to-text converter 250.

Graph-to-text converter 250 converts the received set of characteristics of the graph to an unambiguous text description and sends the same to output interface 260, which forwards the converted text to the digital system requesting text description for the image. In this manner, server system 130 converts a graph image to text description.

Although English text descriptions are shown in the sample data, it may be appreciated that text descriptions may be generated in other languages as well. The text descriptions generated for each image may be stored by server system 130 in data store 120 to avoid processing when there are future requests for the same image. Server system 130 may also store the results of intermediate processing steps to train ML models (e.g., image model 280).

It should be appreciated that the features described above can be implemented in various embodiments as a desired combination of one or more of hardware, software, and firmware. The description is continued with respect to an embodiment in which various features are operative when the software instructions described above are executed.

### 5. Digital Processing System

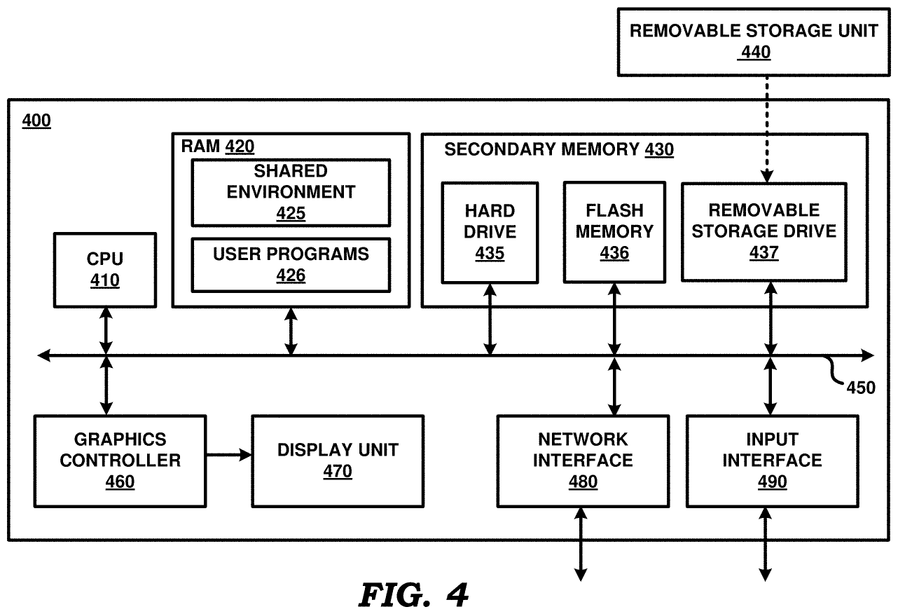

FIG. 4 is a block diagram illustrating the details of digital processing system 400 in which various aspects of the present disclosure are operative by execution of appropriate executable modules. Digital processing system 400 may correspond to server system 130.

Digital processing system 400 may contain one or more processors such as a central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

CPU 410 may execute instructions stored in RAM 420 to provide several features of the present disclosure. CPU 410 may contain multiple processing units, with each processing unit potentially being designed for a specific task. Alternatively, CPU 410 may contain only a single general-purpose processing unit.

RAM 420 may receive instructions from secondary memory 430 using communication path 450. RAM 420 is shown currently containing software instructions constituting shared environment 425 and/or other user programs 426 (such as other applications, DBMS, etc.). In addition to shared environment 425, RAM 420 may contain other software programs such as device drivers, virtual machines, etc., which provide a (common) run time environment for execution of other/user programs.

Graphics controller 460 generates display signals (e.g., in RGB format) to display unit 470 based on data/instructions received from CPU 410. Display unit 470 contains a display screen to display the images defined by the display signals. Input interface 490 may correspond to a keyboard and a pointing device (e.g., touch-pad, mouse) and may be used to provide inputs. Network interface 480 provides connectivity to a network (e.g., using Internet Protocol), and may be used to communicate with other systems connected to the networks (e.g., network 110).

Secondary memory 430 may contain hard drive 435, flash memory 436, and removable storage drive 437. Secondary memory 430 may store the data (e.g., portions of FIG. 3A, 3B and Appendix A, B and C) and software instructions (e.g., for performing the actions associated with FIG. 2), which enable digital processing system 400 to provide several features in accordance with the present disclosure. The code/instructions stored in secondary memory 430 may either be copied to RAM 420 prior to execution by CPU 410 for higher execution speeds, or may be directly executed by CPU 410.

Some or all of the data and instructions may be provided on removable storage unit 440, and the data and instructions may be read and provided by removable storage drive 437 to CPU 410. Removable storage unit 440 may be implemented using medium and storage format compatible with removable storage drive 437 such that removable storage drive 437 can read the data and instructions. Thus, removable storage unit 440 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 440 or hard disk installed in hard drive 435. These computer program products are means for providing software to digital processing system 400. CPU 410 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 430. Volatile media includes dynamic memory, such as RAM 420. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 450. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 6. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of providing assistive services, the method comprising:
receiving, from a user, an image comprising a math content;
processing said image to determine a set of characteristics of said image;
generating a text representing a description of the math content of said image based on said set of characteristics; and
providing said text to said user in an output format suitable for said user.

2. The method of claim 1, wherein said processing determines that said image represents a mathematical equation, said processing and said generating further comprising:
identifying a sequence of tokens as representing the math content of said image; and
converting said sequence of tokens to said text.

3. The method of claim 2, wherein said identifying comprises:
generating a machine learning (ML) equation model that correlates portions of images to tokens; and
predicting said sequence of tokens for said image based on said ML equation model.

4. The method of claim 3, wherein said ML equation model is generated according to sequence-to-sequence ML approach, wherein said sequence of tokens is according to Latex.

5. The method of claim 2, wherein said converting comprises replacing each token in said sequence of tokens with a corresponding term to form a sequence of terms, wherein said sequence of terms represents said text.

6. The method of claim 1, wherein said processing determines that said image represents a graph, said processing comprising:
generating a machine learning (ML) graph model that correlates portions of images to characteristics; and
predicting said set of characteristics for said image based on said ML graph model.

7. The method of claim 6, wherein said ML graph model is generated according to sequence-to-sequence ML approach, wherein said set of characteristics determined for said graph includes a type of the graph, a slope of a line in the graph, and a vertex, roots and direction of a parabola in the graph.

8. The method of claim 1, wherein said output format is an audio corresponding to said text.

9. A digital processing system comprising:
a random access memory (RAM) to store instructions; and
one or more processors to retrieve and execute the instructions, wherein execution of the instructions causes the digital processing system to perform the actions of:
receiving, from a user, an image comprising a math content;
processing said image to determine a set of characteristics of said image;
generating a text representing a description of the math content of said image based on said set of characteristics; and
providing said text to said user in an output format suitable for said user.

10. The digital processing system of claim 9, wherein said processing determines that said image represents a mathematical equation, wherein for said processing and said generating, said digital processing system performs the actions of:
identifying a sequence of tokens as representing the math content of said image; and
converting said sequence of tokens to said text.

11. The digital processing system of claim 10, wherein for said identifying said digital processing system performs the actions of:
generating a machine learning (ML) equation model that correlates portions of images to tokens; and
predicting said sequence of tokens for said image based on said ML equation model.

12. The digital processing system of claim 10, wherein for said converting said digital processing system performs the actions of replacing each token in said sequence of tokens with a corresponding term to form a sequence of terms, wherein said sequence of terms represents said text.

13. The digital processing system of claim 9, wherein said processing determines that said image represents a graph, wherein for said processing said digital processing system performs the actions of:
generating a machine learning (ML) graph model that correlates portions of images to characteristics; and
predicting said set of characteristics for said image based on said ML graph model.

14. The digital processing system of claim 1, wherein said output format is an audio corresponding to said text.

15. A non-transitory machine-readable medium storing one or more sequences of instructions for providing assistive services, wherein execution of said one or more instructions by one or more processors contained in a digital processing system causes said digital processing system to perform the actions of:
receiving, from a user, an image comprising a math content;
processing said image to determine a set of characteristics of said image;
generating a text representing a description of the math content of said image based on said set of characteristics; and
providing said text to said user in an output format suitable for said user.

16. The non-transitory machine-readable medium of claim 15, wherein said processing determines that said image represents a mathematical equation, said processing and said generating further comprising one or more instructions for:
identifying a sequence of tokens as representing the math content of said image; and
converting said sequence of tokens to said text.

17. The non-transitory machine-readable medium of claim 16, wherein said identifying comprises one or more instructions for:
generating a machine learning (ML) equation model that correlates portions of images to tokens; and
predicting said sequence of tokens for said image based on said ML equation model.

18. The non-transitory machine-readable medium of claim 16, wherein said converting comprises one or more instructions for replacing each token in said sequence of tokens with a corresponding term to form a sequence of terms, wherein said sequence of terms represents said text.

19. The non-transitory machine-readable medium of claim 15, wherein said processing determines that said image represents a graph, said processing comprising one or more instructions for:
generating a machine learning (ML) graph model that correlates portions of images to characteristics; and
predicting said set of characteristics for said image based on said ML graph model.

20. The non-transitory machine-readable medium of claim 15, wherein said output format is an audio corresponding to said text.
